(19) United States
(12) Patent Application Publication
(10) Pub. No.: US 2016/0063877 A1
(43) Pub. Date: Mar. 3, 2016

(54) Interactive Page Turning

(71) Applicant: Google, Inc., Mountain View, CA (US)

(72) Inventors: Ali Javan Javidan, Sunnyvale, CA (US); Frank Vincent Savino, San Carlos, CA (US); Aaron Arthur Weiss, Mountain View, CA (US); Norbert B. Tydingco, Newark, CA (US); Mark Anthony Zarich, Oakland, CA (US)

(21) Appl. No.: 14/591,684

(22) Filed: Jan. 7, 2015

Related U.S. Application Data
(60) Provisional application No. 62/045,462, filed on Sep. 3, 2014.

(51) Int. Cl. G09B 5/06

(52) U.S. Cl. CPC G09B 5/065; G09B 5/062

(57) ABSTRACT

This document describes interactive page turning A book includes physical pages, and one or more sensors that sense when the physical pages are turned. Turning the physical pages causes a media device to provide a story enhancement effect, such as outputting audio via a speaker, outputting light through a light source, or displaying media content on a display.

### PRIORITY APPLICATION

This application is a non-provisional of and claims priority under 35 U.S.C. §119(e) to U.S. Patent Application Ser. No. 62/045,462, titled “Interactive Page Turning,” and filed on Sep. 3, 2014, the disclosure of which is incorporated by reference herein in its entirety.

### BACKGROUND

Recently some books, such as children's books, include an audio component that enriches the experience of reading the book. For example, the audio component may include physical control buttons and a speaker attached to the side of the book. The book itself may include words, pictures, and written instructions that tell the reader to press specific buttons on the audio component to cause audio to be played via the speaker.

### SUMMARY

This document describes interactive page turning A book includes physical pages, and one or more sensors that sense when the physical pages are turned. Turning the physical pages causes a media device to provide a story enhancement effect, such as outputting audio via a speaker, outputting light through a light source, or displaying media content on a display.

This summary is provided to introduce simplified concepts concerning techniques and devices for interactive page turning, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and devices for interactive page turning are described with reference to the following drawings. The same numbers are used throughout the drawings to reference like features and components:

FIG. 1 is an illustration of an example environment in which interactive page turning may be implemented.

FIG. 2 illustrates an example system in which a media device provides story enhancement effects in accordance with various implementations.

FIG. 3 is an illustration of an example environment in which the media device is implemented as a storytelling device.

FIG. 4 is an illustration of an additional example environment in which the media device is implemented as a computing device.

FIG. 5 illustrates an example method of sensing motion of a page turn.

FIG. 6 illustrates an example method of providing a story enhancement effect based on a page turn.

FIG. 7 illustrates various components of an example computing system that can be implemented as any type of computing device as described with reference to the previous FIGS. 1-6 to implement book 102 or media device 110.

### DETAILED DESCRIPTION

Overview

This document describes interactive page turning A book includes physical pages, and one or more sensors that sense when the physical pages are turned. Turning the physical pages causes a media device to provide a story enhancement effect, such as outputting audio via a speaker, outputting light through a light source, or displaying media content on a display.

Example Environment

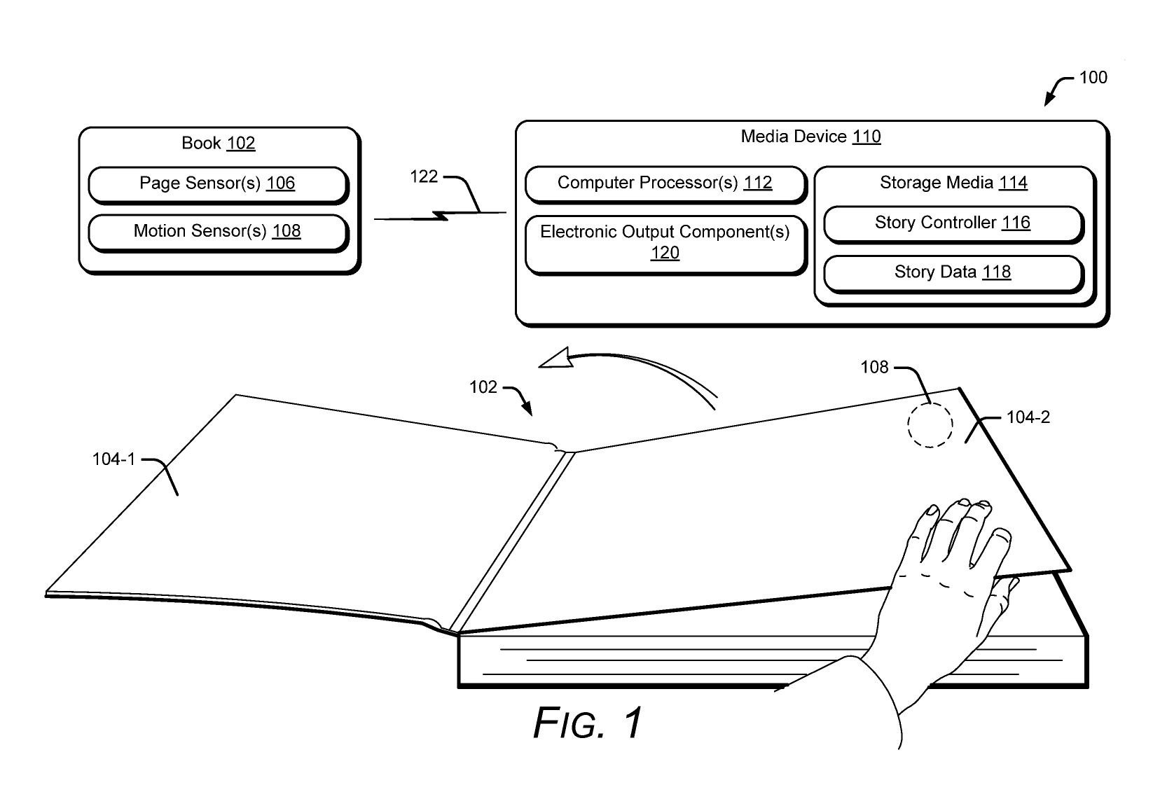

FIG. 1 is an illustration of an example environment 100 in which interactive page turning may be implemented.

Environment 100 includes a book 102. Book 102 is a physical book and includes physical pages (“pages”) 104, which may be implemented with a physical material such as paper, cardboard, or plastic, to name just a few. Each page 104 of book 102 may include text or images like many standard physical books. In this example, book 102 is open to a first page 104-1 positioned to the left of the center of book 102, and a second page 104-2 positioned to the right of the center of book 102.

Book 102 includes sensors, which may include page sensor(s) 106 and motion sensor(s) 108. Page sensors 106 and motion sensors 108 may be integrated with book 102, such as by being embedded within pages 104 of book 102 or in the spine of book 102.

Page sensor 106 is configured to sense a current page (or pages) 104 of book 102 that is currently open, and to output page data indicating the current page 104. In FIG. 1, for example, page sensor 106 may detect that current pages 104-1 and 104-2 are currently open, and can detect next pages 104 after the reader turns page 104-2.

In one or more implementations, page sensor 106 is implemented as a flex sensor. Flex sensors are configured to change in resistance or voltage when they flex or bend. For example, the flex sensor may output a high resistance value with a high amount of bend, and a low resistance value with a low amount of bend. Thus, the flex sensor may be attached around the hinge of book 102 to sense the current page 104 of book 102 that is open.

Motion sensor 108 is configured to sense a page turn. To do so, motion sensor 108 can sense motion of page 104 when the page is turned, and generate motion data indicating the motion of the page turn. Motion sensor 108 may be implemented as any type of sensor that can sense movement or motion of a page turn, such as an accelerometer, a gyroscope, and so forth. In some cases, the motion data may include a speed or an acceleration of the page turn. For instance, motion sensor 108 may be implemented as an accelerometer to detect the acceleration of the page turn.

Motion sensor 108 may be embedded in one or more pages 104 of book 102. In FIG. 1, for example, motion sensor 108 is embedded into the top right corner of page 104-2 of book 102. As the user turns page 104-2, motion sensor 108 senses motion of the page (e.g., acceleration of the page), and generates motion data.

The motion data and page data is communicated to a media device 110 to enable the media device to provide various story enhancement effects that are based, at least in part, on the motion data and/or the page data.

Media device 110 includes one or more computer processors 112 and computer-readable storage media (storage media) 11. Applications and/or an operating system (not shown) embodied as computer-readable instructions on storage media 114 can be executed by computer processors 112 to provide some or all of the functionalities described herein. Storage media 114 also includes a story controller 116 and story data 118, which will be described in more detail below.

Media device 110 also includes electronic output components 120, which may include, by way of example and not limitation, light sources, speakers, video projectors, or a display. Light sources may be implemented as any type of light source, such as LEDs.

In accordance with various implementations, story controller 116 is configured to enhance the reading of book 102 by controlling electronic output components 120 (e.g., speakers, light sources, displays, or video projectors) to provide story enhancement effects. As described herein, a “story enhancement effect” corresponds to output by one or more electronic output components, such as playing audio through a speaker, outputting light using a light source, or displaying video using a video projector or a display.

Story data 118 associates or maps various story enhancement effects with specific pages of book 102. For example, a certain story enhancement effect may be associated with specific pages, such as pages 10 and 11, of book 102. When these pages are open, story controller 116 receives an indicator of the pages from page sensor 106, and provides the associated story enhancement effect.

Story data 118 also associates or maps various story enhancement effects with page turns of book 102. Thus, turning a page 104 of book 102 may trigger specific story enhancement effects. In one or more implementations, story data 118 may also associate certain rates, speeds, or accelerations of page turns (e.g., fast, normal, or slow) with specific story enhancement effects. Thus, turning a page fast, normal, or slow, may cause story controller 116 to provide different story enhancement effects.

In one or more implementations, media device 110, including story controller 116, story data 118, and electronic output component 120, is physically integrated with book 102. When integrated with book 102, story controller 116 may communicate with page sensor 106 and motion sensor 108 via circuitry embedded in the pages of book 102.

Alternately, media device 110 may be implemented as a computing device remote from book 102. In these cases, story controller 116 can communicate with page sensor 106 and motion sensor 108 via a wired or wireless connection 122 to book 102. For example, book 102 and media device 110 may each include a wired or wireless interface to enable the exchange of data and information over wired or wireless connection 122. Story controller 116 can control electronic output components 120 that are located at media device 110 and/or at book 102. For example, electronic output components 120 can be located only at book 102, only at media device 110, or at both book 102 and media device 110.

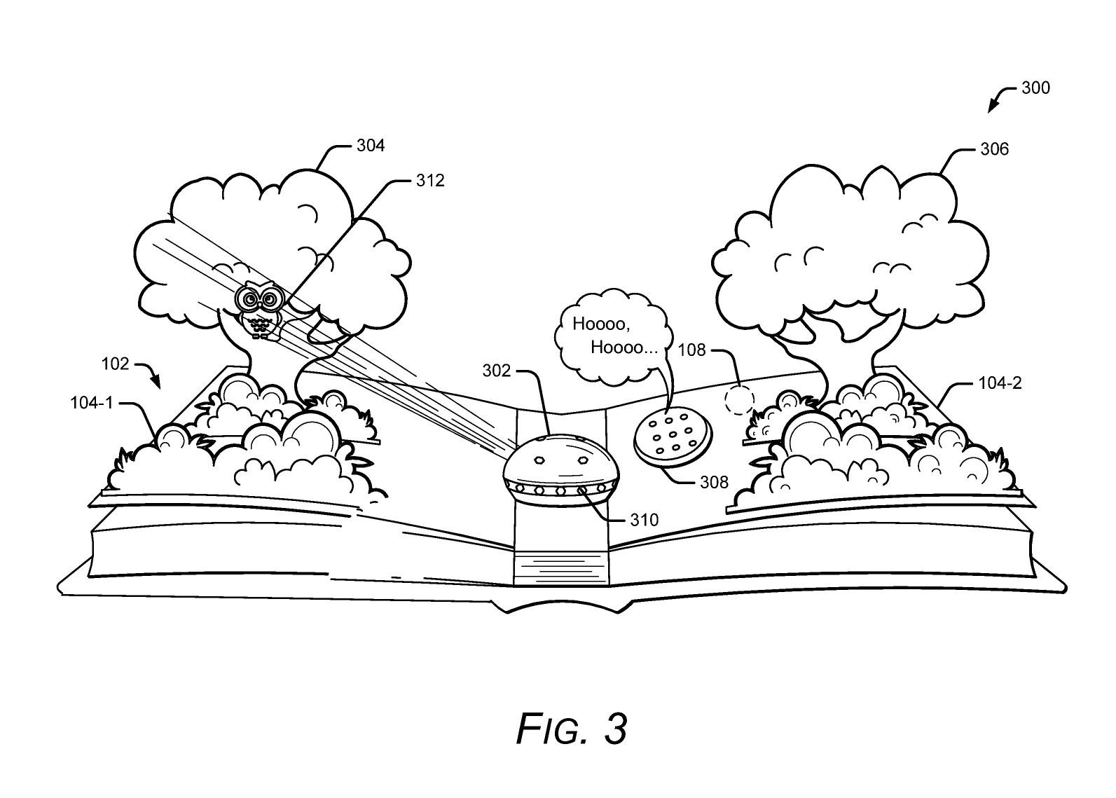

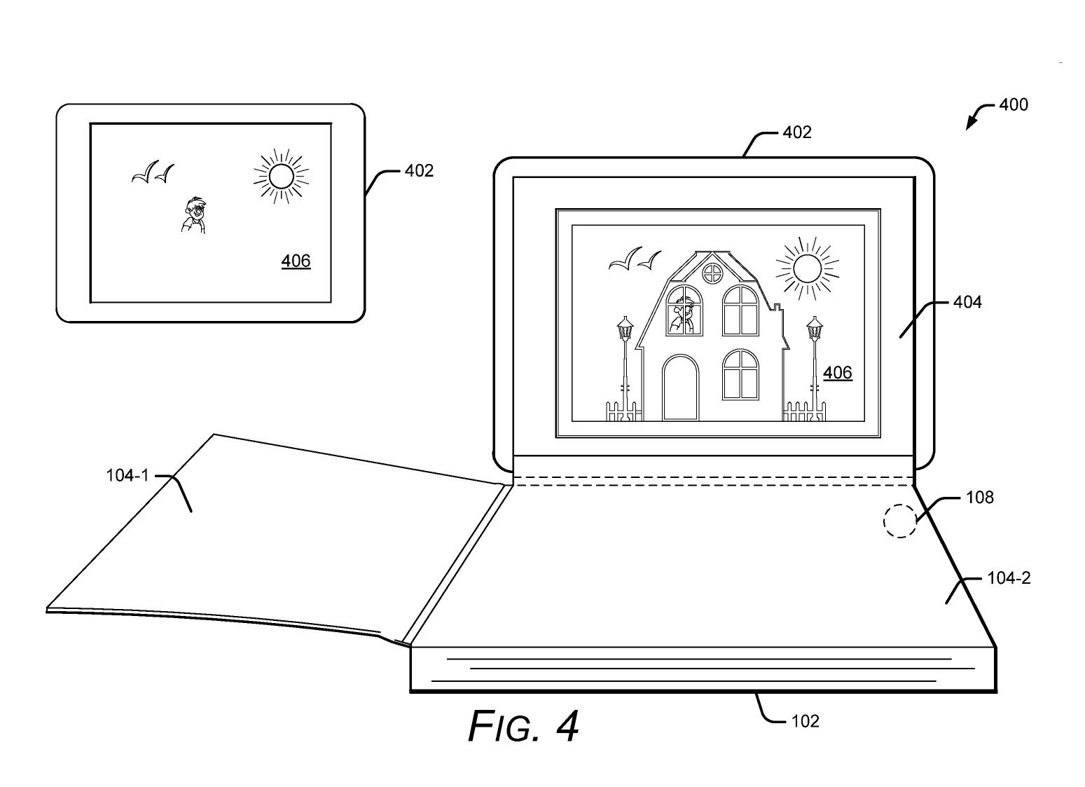

When implemented as a computing device remote from book 102, media device 110 may be configured in a variety of different ways. Media device 110, for instance, may be configured as a tablet computing device, a desktop computer, a laptop computer, a smartphone, a television device, an entertainment device, a gaming device, or any other type of device. Thus, media device 110 may range from full resource devices with substantial memory and processor resources (e.g., desktop computers) to a low-resource device with limited memory and/or processing resources (e.g., smartphones). In one or more implementations, media device 110 may be configured as a storytelling device that is specifically configured to provide story enhancement effects for book 102. An example of a storytelling device is discussed with reference to FIG. 3 below, and an example of a remote computing device is discussed with reference to FIG. 4 below.

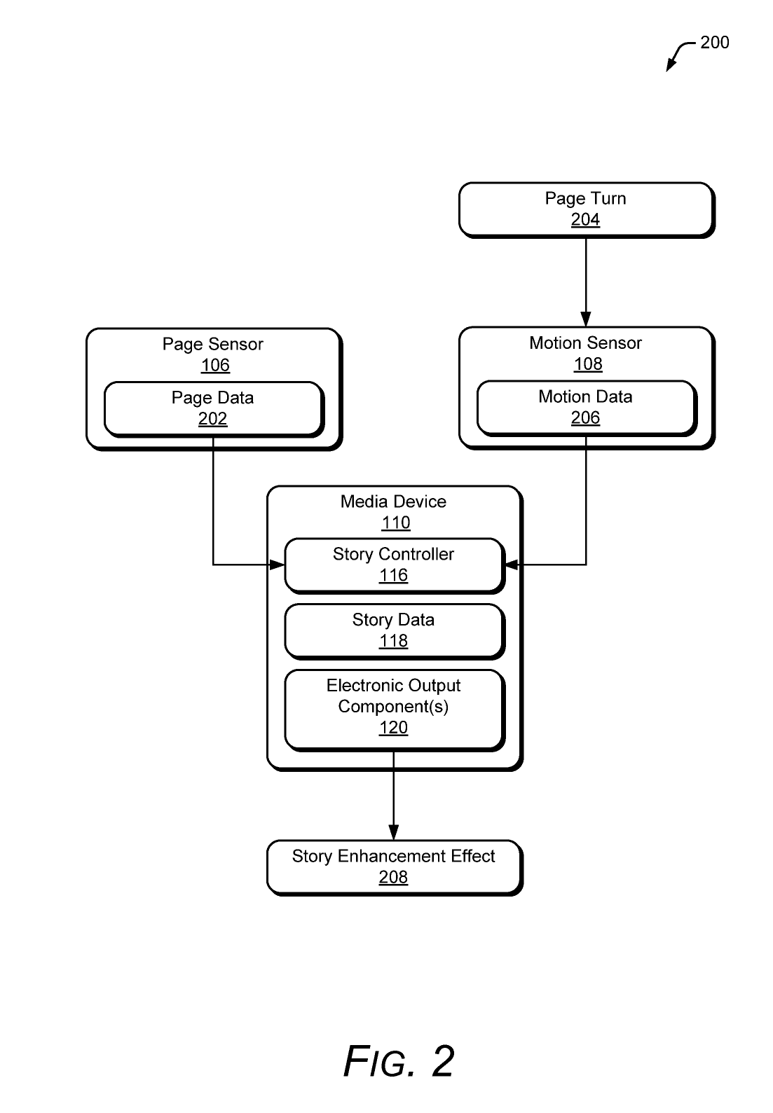

FIG. 2 illustrates an example system 200 in which media device 110 provides story enhancement effects in accordance with various implementations.

In example 200, page sensor 106 sense a current page 104 (or pages) of book 102 that is currently open, and generates page data 202 which indicates the current page. In some cases, page sensor 106 may be unable to sense the current page 104 until the book is completely open to the particular pages. In FIG. 1, for example, page sensor 104 can sense pages 104-1 and 104-2. However, as the user turns page 104-2, page sensor 106 may be unable to sense the next pages until page 104-2 is completely turned. Page data 202 is then communicated to story controller 116, as described above.

As the reader begins interacting with book 102, a page turn 204 occurs when the reader turns a page of book 102. For instance, in FIG. 1, page turn 204 occurs when the user turns page 104-2 to read the next page of book 102. Each time a page turn 204 occurs, motion sensor 108, embedded in the page being turned, senses motion of page turn 204 and generates motion data 206.

Motion data 206 provides a notification to story controller 116 that the page is being turned. In at least some implementations, motion data 206 also indicates a speed or an acceleration of page turn 204. For example, when motion sensor 108 is implemented as an accelerometer, motion data 206 may indicate the acceleration of page turn 204. Motion data 206 may be communicated to story controller 116 in real-time (e.g., as the page is being turned).

Responsive to receiving motion data 206, story controller 116 determines a story enhancement effect 208 that is based, at least in part, on motion data 206. Story controller 116 then communicates control signals to one or more electronic output components 120 to cause the electronic output component to provide story enhancement effect 208. For example, story controller 116 may communicate control signals to speakers, integrated with book 102 or remote from book 102, to cause the speakers to play a particular song or sound effect. As another example, story controller 116 may communicate control signals to light sources, such as LEDs, to cause the light sources to output various lighting effects, such as shining light in particular locations of book 102, blinking, twinkling, and so forth. As noted above, story controller 116 and electronic output components 120 may be local or remote to book 102. Thus, in some cases story controller 116 communicates the control signals and data to electronic output components 120 via a wired or wireless connection 122.

To determine which story enhancement effect to provide, story controller 116 compares motion data 206 to story data 118, and selects the story enhancement effect that is associated with the particular motion data in story data 118. In one or more implementations, the selection of the story enhancement effect is also based on page data 202. In FIG. 1, for example, story controller 116 can select a story enhancement effect based on pages 104-1 and 104-2 being open and based on motion data associated with page 104-2. A variety of different story enhancement effects 208 may be triggered by motion data 206, which may correspond to the page being turned and/or the speed or acceleration associated with page turn 204.

In one or more implementations, turning a page 104 of book 102 may cause story controller 116 to stop providing a story enhancement effect associated with a current page 104. In FIG. 1, for example, when page 104-2 is turned forward in book 102, motion data 206 indicates to story controller 116 that the reader is turning away from pages 104-1 and 104-2. Thus, story controller 116 may cause a story enhancement effect, associated with page 104-1 and/or 104-2, to stop.

Alternately or additionally, turning a page 104 of book 102 may cause story controller 116 to provide a story enhancement effect that is associated with the action of turning the particular page. In FIG. 1, for example, when page 104-2 is turned forward in book 102, motion data 206 may cause story controller 116 to provide a story enhancement effect that is associated with the turning of the page, such as by causing a speaker to play a particular song or sound effect as the page is turned.

In some cases, story controller 116 may provide different story enhancement effects based on the speed or acceleration of the page turn. To do so, story controller 116 may compare the speed or acceleration of page turn 204, indicated by motion data 206, to one or more predetermined thresholds. The predetermined thresholds can be used to determine if page turn 204 is slow, normal, or fast. For example, a normal speed may correspond to the speed at which a reader would normally turn a page of a book to read the next page. Thus, a slower speed may correspond to a speed that is slower than the speed of a normal page turn, whereas a fast speed may correspond to a speed that is faster than normal. The fast speed, for example, may occur when the reader flips through multiple pages to get to a specific page of book 102.

Story controller 116 can cause electronic output components 120 to provide a first story enhancement 208 effect if the speed or acceleration of the page turn is greater than the predetermined threshold, and cause electronic output components 120 to provide a second story enhancement effect if the acceleration of the page turn is less than the predetermined acceleration threshold. For example, if the page is being turned slowly, story controller 116 may initiate a first story enhancement effect, whereas if the page is being turned quickly, story controller 116 may initiate a second, different, story enhancement effect.

As an example, consider that book 102 tells a story about a young boy who meets a friendly lion that lives in a cave. On a current page of book 102, book 102 may describe that the boy is about to walk into the cave where the friendly lion lives, and that the boy is scared to go into the cave. Thus, when the user turns the page, the turning of the page may cause story controller 116 to control a speaker to output the sound of a lion roaring. This provides the reader with the feeling that the reader is entering the cave, just like the young boy. Further, if the reader slowly turns the page, story controller 116 may cause the sound of the lion roaring to increase in volume.

In one or more implementations, story controller 116 may not provide story enhancement effect 208 if the speed or acceleration of page turn 204 is above a predetermined threshold. The predetermined threshold may be set such that fast page turns, which correspond to the user flipping through pages 104 of book 102 to get to a certain page, will be greater than the predetermined threshold. Note that when the reader is quickly flipping through pages, that it doesn't make sense to start, and then abruptly stop, story enhancement effects on each page turn. Thus, as the user begins flipping through pages 104, story controller 116 determines that the speed or acceleration of page turn 204 is above the predetermined threshold, and does not initiate the story enhancement effect.

In one or more implementations, turning a page 104 of book 102 may cause story controller 116 to provide a story enhancement effect associated with a next page 104 of book 102. In FIG. 1, for example, when page 104-2 is being turned forward in book 102, motion data 206 indicates to story controller 116 that the reader is turning to next pages 104 of book 102. Thus, story controller 116 may provide a story enhancement effect, associated with the next pages 104 of book 102 that are after pages page 104-1 and 104-2.

Notably, motion data 206 may also enable story controller 116 to initiate or queue up the story enhancement associated with the next page before page sensor 106 senses that the next page is open. For example, if the reader is reading pages 9 and 10 of book 102, and then turns page 10 to turn to next pages 11 and 12, motion data 206 will be generated by motion sensor 108 as the user begins to turn page 10. This enables story controller 116 to determine that pages 11 and 12 are being turned to prior to page sensor indicating that pages 11 and 12 are open. Thus, story controller 116 can cease to provide the story enhancement effect for pages 9 and 10, and initiate or queue up the story enhancement effect for pages 11 and 12 as the reader begins to turn page 10. This enables story controller 116 to quickly provide the story enhancement effect associated with the next pages.

While the examples above provide a variety of different ways that story controller 116 can utilize motion data 206 and/or page data 202 to determine and provide story enhancement effects 208, it is to be appreciated that a variety of other scenarios are contemplated. For example, story data 118 may associate a variety of different story enhancement effects with any combination of page data 202 and motion data 206.

Consider now various implementation examples in which media device 110 is implemented at a device remote from book 102. Note that these examples are non-limiting, and that media device 110 may also be implemented with book 102 or with a variety of different devices other than those described below.

FIG. 3 illustrates an example environment 300 in which media device 110 is implemented as a storytelling device 302. Storytelling device 302 is a separate device that is specifically configured to provide story enhancement effects for book 102 when attached to book 102.

In this example, book 102 includes three-dimensional pop-up elements (“pop-up elements), which pop-up and out of pages 104 of book 102 when the reader turns to a particular page. Such pop-up elements may commonly be found in children's books, and may be made from any type of sturdy material, such as cardboard, plastic, and so forth. In environment 300, the pop-up elements include trees 304 and 306, which pop-up from book 102 when the reader turns to pages 104-1 and 104-2.

Motion sensor 108 is embedded in page 104-2, and a flex sensor is embedded in the spine of book 102 (not pictured). In addition, both book 102 and storytelling device 302 include electronic output components 120. Book 102 includes a speaker 308 that is integrated within page 104-2 of book 102, and storytelling device 302 includes light sources 310 positioned around an outer surface of storytelling device 302. Note that the positioning of storytelling device 302 when attached to book 102 enables storytelling device 302 to shine light from light sources 310 to illuminate a currently opened page 104 (e.g., the page currently being read by the reader) of book 102.

Book 102 is configured to establish an electronic connection with storytelling device 302, which enables data and control signals to be transferred between book 102 and storytelling device 302. In this example, storytelling device 302 is connected to the spine of book 102, such that storytelling device 302 is positioned in the center of book 102 when opened. For example, each page of book 102 includes a hole in the center that enables storytelling device 302 to connect to the spine of book 102.

Story controller 116, implemented at storytelling device 302, is configured to control electronic output components 120 at both storytelling device 302 (e.g., light sources 310) and at book 102 (e.g., speaker 308) to provide story enhancement effects based on page data and/or motion data received from page sensor 106 and motion sensor 108, respectively.

For example, as the user turns page 104-2 to open book 102 to current pages 104-1 and 104-2, story controller 116 can control speaker 308 to play the sound “hoooo, hoooo”, which corresponds to the sound an owl makes. In addition, as the page is turned, story controller 116 can queue up, or load, control signals usable to control light sources 310 to illuminate an owl 312 in tree 304. Then, when book 102 is turned to pages 104-1 and 104-2, story controller 116 causes light sources 310 to illuminate owl 312 in tree 304, which enables the reader to see the owl. Note, therefore, that the story enhancement effects are specifically correlated book 102. The light sources are controlled to illuminate an exact area of the tree at which owl 312 is located, and the speakers are controlled to make the “hoooo, hoooo” sound as the user turns the page.

In some cases, a different sound could be played by speaker 308 if the user slowly turns the page, such as “hurry up, let's go!”—which could correspond to a boy in the story telling the reader to hurry up and turn to the next page. As another example, if the user quickly turns the page, story controller 116 may determine that the user is simply flipping through pages. In this case, the owl sound may not be initiated, and the lights may not be controlled to shine into the tree.

While storytelling device 302 is described as separate device, it is to be appreciated that a device similar to storytelling device 302 could be integrated within book 102.

FIG. 4 is an illustration of an additional example environment 400 in which media device 110 is implemented as a computing device 402.

In example 400, book 102 includes three-dimensional pop-up pages (“pop-up pages”) 404, which pop-up and out of book 102 as the reader turns pages 104 of book 102. Pop-up pages 404 may be made from any type of sturdy material, such as cardboard, plastic, and so forth. Each pop-up page 404 is associated with two adjacent pages of book 102. For example, in FIG. 4, pop-up page 404 is associated with first page 104-1 positioned on the left, and second page 104-2 positioned on the right. When book 102 is opened to pages 104-1 and 104-2, pop-up page 404 pops-up substantially perpendicular to pages 104-1 and 104-2.

In this example, computing device 402 is illustrated as a tablet computing device. However, computing device 402 may be implemented as any type of computing device, such as a smartphone, a laptop, or a television, to name just a few. Computing device 402 is configured to be positioned behind book 102. Alternately, however, computing device 402 may be positioned at a different location and still provide various story enhancement effects, such as playing audio sounds.

In this case, electronic output components 120 include a display 406 of computing device 402, and speakers (not pictured). Display 406 may be implemented as any type of display, such as a liquid crystal display.

Motion sensor 108 is embedded in page 104-2, and page sensor 106, in the form of a flex sensor, may be embedded in the spine of book 102 (not pictured). Alternately, to enable identification of pop-up page 404, electronic identifiers may be embedded within each pop-up page 404 which are detectable by computing device 402. For example, in some cases near field communication (NFC) tags or patterns of touch input points may be embedded into pop-up pages 404, which are detectable by computing device 402. For example, computing device 402 may include an NFC sensor that is configured to detect NFC tags when pop-up pages 404 pop-up in front of computing device 402. Alternately or additionally, computing device 402 may include a touchscreen display that is configured to detect patterns of touch input points when pop-up pages 404 pop-up in front of computing device 402.

Pop-up page 404 includes artwork that enables media content displayed on display 406 of computing device 402 to be viewable through the artwork when display 406 is positioned behind book 102. In this example, the artwork includes a house, a fence, and lampposts. The material of pop-up page 404 around the house, fence, and lampposts is cut-out which enables display 406, positioned behind pop-up page 404, to be partially viewable. In addition, the areas corresponding to windows and doors in the house are also cut-out. In some cases, instead of cut-outs, pop-up page 404 may include transparent or semi-transparent portions (e.g., pieces of vellum) which enables display 406 to be viewable through pop-up page 404.

Pop-up page 404 is controlled to pop-up and out of book 102 directly in front of display 406. When this occurs, story controller 116, implemented at computing device 402, is configured to control electronic output components 120 (e.g., display 406 and/or speakers) to provide story enhancement effects based on page data and/or motion data received from page sensor 106 and motion sensor 108, respectively.

For example, as the user turns page 104-2 to open book 102 to current pages 104-1 and 104-2, story controller 116 can control the speaker to play a sound such as “hey, I'm up here in the window!”, which may correspond to the voice of the boy in the window.

In addition, as the page is turned, story controller 116 can queue up, or load, control signals usable to control display 406 to provide the story enhancement effects.

Then, when book 102 is opened to pages 104-1 and 104-2, and pop-up page 404 pops-up in front of display 406, story controller 116 detects the current page and provides a story enhancement effect by presenting media content on display 406 to visually enhance the artwork of pop-up page 404. For example, computing device 402 can present media content in areas of display 406 that is viewable through pop-up page 404 (e.g., areas which include cut-outs of transparent material), and which is specifically indented to visually enhance the artwork of pop-up page 404.

In FIG. 4, display 406 presents media content that includes images or video of a sun, birds, and a child which visually enhance and bring to life the artwork of pop-up page 404. For example, the sun and birds and bring to life the area around the house of pop-up page 404, and the child appears to be in the window of the house. Note that the sun, the birds, and the child may be implemented as non-moving images, or as video. For example, when implemented as video, the child could wave or talk and the birds could fly across the sky.

Example Methods

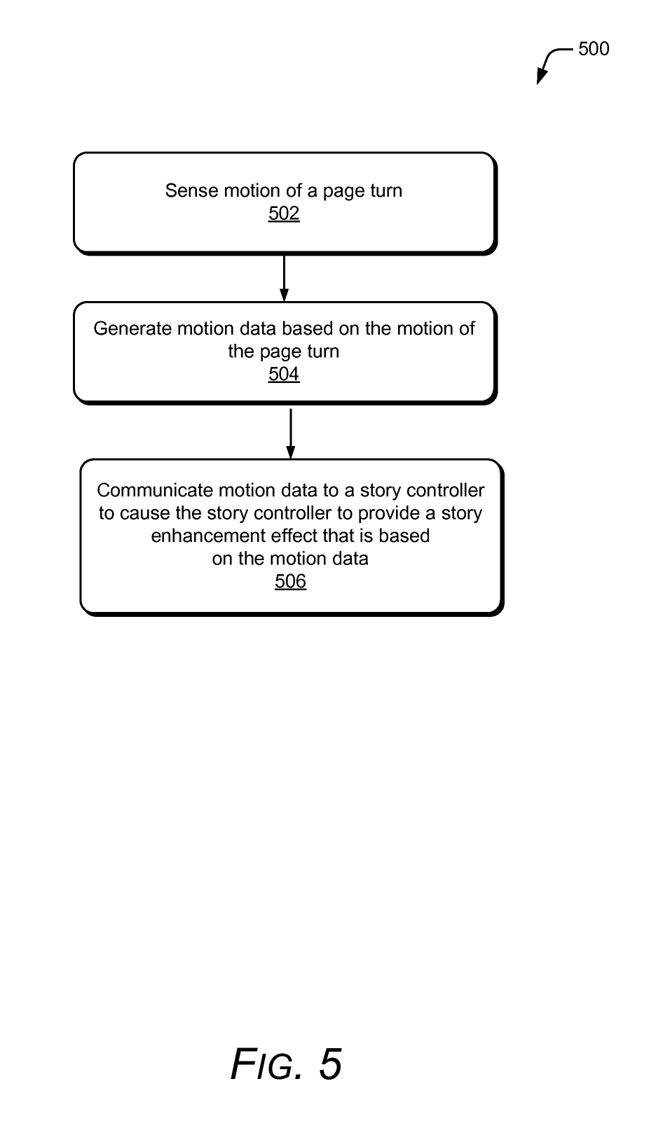

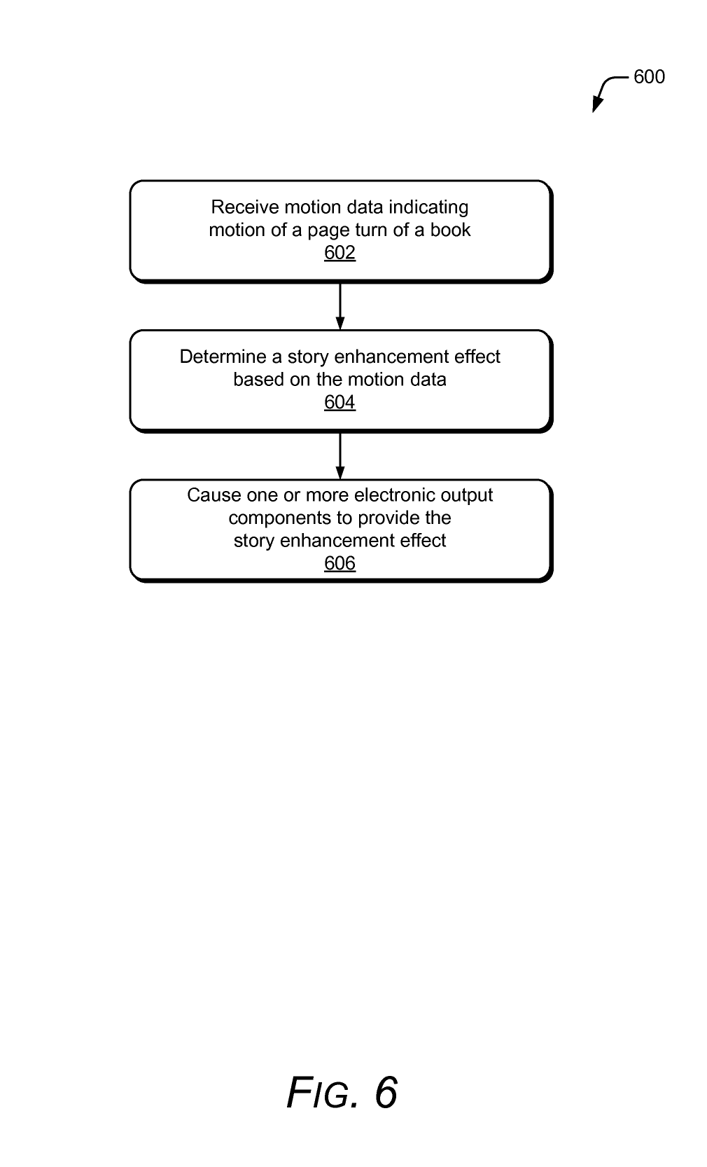

FIG. 5 illustrates an example method 500 of sensing motion of a page turn, and FIG. 6 illustrates an example method 600 of providing a story enhancement effect based on a page turn. These methods and other methods herein are shown as sets of blocks that specify operations performed but are not necessarily limited to the order or combinations shown for performing the operations by the respective blocks. In portions of the following discussion reference may be made to environment 100 of FIG. 1 and system 200 of FIG. 2, reference to which is made for example only. The techniques are not limited to performance by one entity or multiple entities operating on one device.

FIG. 5 illustrates an example method 500 of sensing motion of a page turn. At 502, motion of a page turn is sensed. For example, motion sensor 108 embedded within a page 104 of book 102 senses motion corresponding to a page turn 204 when the reader turns page 104.

At 504, motion data is generated based on the motion of the page turn. For example, motion sensor 108 generates motion data 206 based on the motion of page turn 204. Motion data 206 may provide an indication that page 104 is being turned. Additionally, motion data 206 may indicate a speed or acceleration of page turn 204.

At 506, the motion data is communicated to a story controller to cause the story controller to provide a story enhancement effect 208 that is based on motion data 206.

In one or more implementations, book 102 includes a page sensor 106 configured to sense a current physical page 104 of the book that is open, and to generate page data 202 indicating the current physical page of the book that is open. In this case, book 102 may communicate the page data to story controller 116 to cause story controller 116 to can provide a story enhancement effect that is based on both the motion data and the page data.

FIG. 6 illustrates an example method 600 of providing a story enhancement effect based on a page turn. At 602, motion data indicating motion of a page turn of a book is received. For example, story controller 116 receives motion data 206 indicating motion of a page turn 204 of book 102.

At 604, a story enhancement effect is determined based on the motion data. For example, story controller 116 determines a story enhancement effect 208 based on motion data 206.

At 606, the one or more electronic output components are caused to provide the story enhancement effect. For example, story controller 116 causes electronic output components 120 to provide story enhancement effect 208 by communicating control signals to electronic output components 120.

In one or more implementations, prior to receiving the motion data, story controller 116 can receive page data 202 indicating a current page 104 of book 102 that is open. In this case, story controller 116 may determine the story enhancement effect based on the both the motion data indicating the motion of the page turn and on the page data indicating the current page of the book that is open.

Example Computing System

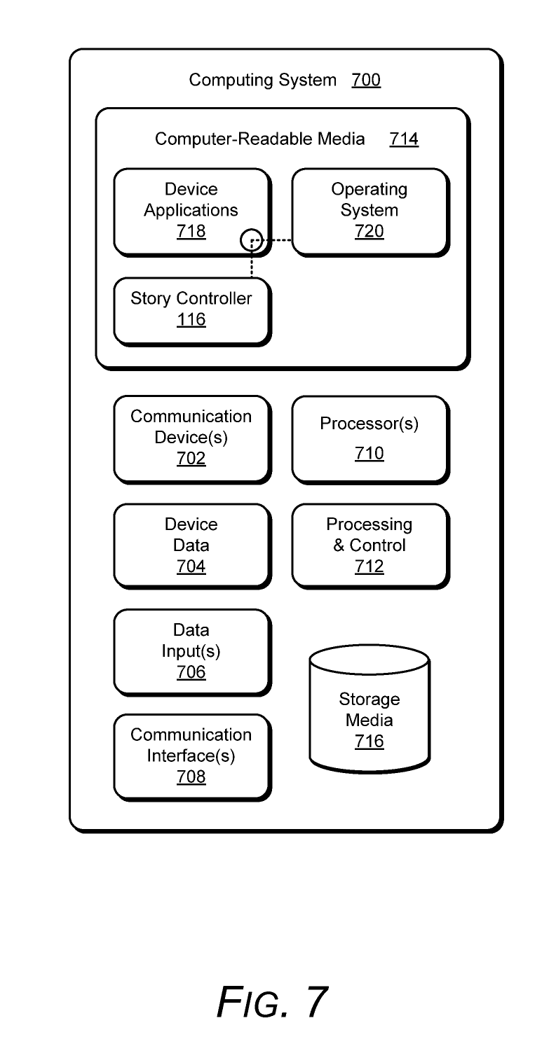

FIG. 7 illustrates various components of an example computing system 700 that can be implemented as any type of client, server, and/or computing device as described with reference to the previous FIGS. 1-6 to implement interactive page turning. In embodiments, computing system 700 can be implemented as one or a combination of a wired and/or wireless wearable device, System-on-Chip (SoC), and/or as another type of device or portion thereof. Computing system 700 may also be associated with a user (e.g., a person) and/or an entity that operates the device such that a device describes logical devices that include users, software, firmware, and/or a combination of devices.

Computing system 700 includes communication devices 702 that enable wired and/or wireless communication of device data 704 (e.g., received data, data that is being received, data scheduled for broadcast, data packets of the data, etc.). Device data 704 or other device content can include configuration settings of the device, media content stored on the device, and/or information associated with a user of the device. Media content stored on computing system 700 can include any type of audio, video, and/or image data. Computing system 700 includes one or more data inputs 704 via which any type of data, media content, and/or inputs can be received, such as human utterances, user-selectable inputs (explicit or implicit), messages, music, television media content, recorded video content, and any other type of audio, video, and/or image data received from any content and/or data source.

Computing system 700 also includes communication interfaces 708, which can be implemented as any one or more of a serial and/or parallel interface, a wireless interface, any type of network interface, a modem, and as any other type of communication interface. Communication interfaces 708 provide a connection and/or communication links between computing system 700 and a communication network by which other electronic, computing, and communication devices communicate data with computing system 700.

Computing system 700 includes one or more processors 710 (e.g., any of microprocessors, controllers, and the like), which process various computer-executable instructions to control the operation of computing system 700 and to enable techniques for, or in which can be embodied, book 102 and media device 110. Alternatively or in addition, computing system 700 can be implemented with any one or combination of hardware, firmware, or fixed logic circuitry that is implemented in connection with processing and control circuits which are generally identified at 712. Although not shown, computing system 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 700 also includes computer-readable media 714, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 700 can also include a mass storage media device 716.

Computer-readable media 714 provides data storage mechanisms to store device data 704, as well as various device applications 718 and any other types of information and/or data related to operational aspects of computing system 700. For example, an operating system 720 can be maintained as a computer application with computer-readable media 714 and executed on processors 710. Device applications 718 may include a device manager, such as any form of a control application, software application, signal-processing and control module, code that is native to a particular device, a hardware abstraction layer for a particular device, and so on.

Device applications 718 also include any system components, engines, or managers to implement book 102 and/or media device 110. In this example, device applications 718 include story controller 116.

### CONCLUSION

Although embodiments of interactive page turning have been described in language specific to features and/or methods, it is to be understood that the subject of the appended claims is not necessarily limited to the specific features or methods described. Rather, the specific features and methods are disclosed as example implementations of a interactive page turning.

What is claimed is:

1. A book comprising:
physical pages; and
one or more motion sensors attached to one or more of the physical pages of the book, each of the one or more motion sensors configured to sense motion of a page turn of a respective physical page, and to generate motion data indicating the motion of the page turn;
the book configured to communicate the motion data to a story controller to cause the story controller to provide a story enhancement effect.

2. The book as recited in claim 1, further comprising a page sensor configured to sense a current physical page of the book that is open, and to generate page data indicating the current physical page of the book that is open.

3. The book as recited in claim 2, wherein the page sensor comprises a flex sensor integrated into a spine of the book.

4. The book as recited in claim 2, wherein the book is further configured to communicate the page data to the story controller, and wherein the story controller provides a story enhancement effect that is based on both the motion data and the page data.

5. The book as recited in claim 1, wherein the motion sensor comprises an accelerometer configured to sense acceleration of the page turn.

6. The book as recited in claim 1, further comprising one or more electronic output components, wherein the story controller is integrated with the book and controls the one or more electronic output components to provide the story enhancement effect.

7. The book as recited in claim 6, wherein the one or more electronic output components comprise one or more of a speaker, one or more light sources, or a display.

8. The book as recited in claim 1, wherein the story controller is located at a remote computing device, and wherein communicating the motion data to the story controller causes the story controller to provide a story enhancement effect using one or more electronic output components located at the remote computing device.

9. A method comprising:
receiving motion data indicating motion of a page turn of a book;
determining a story enhancement effect based on the motion data; and
causing one or more electronic output components to provide the story enhancement effect.

10. The method as recited in claim 9, wherein the motion data indicates acceleration of the page turn.

11. The method as recited in claim 10, further comprising comparing the acceleration of the page turn to a predetermined acceleration threshold, wherein the causing the story enhancement effect comprises causing the one or more electronic output components to provide a first story enhancement effect if the acceleration of the page turn is greater than the predetermined threshold, and causing the one or more electronic output components to provide a second story enhancement effect if the acceleration of the page turn is less than the predetermined acceleration threshold.

12. The method as recited in claim 10, further comprising comparing the acceleration of the page turn to a predetermined acceleration threshold, and wherein the causing the one or more electronic output components to provide the story enhancement effect comprises not providing the story enhancement effect if the acceleration of the page turn is greater than the predetermined acceleration threshold.

13. The method as recited in claim 9, further comprising prior to receiving the motion data, receiving page data indicating a current page of the book that is open, and wherein the determining the story enhancement effect comprises determining the story enhancement effect based on the both the motion of the page turn and the current page of the book that is open.

14. The method as recited in claim 13, wherein the story enhancement effect is associated with a next page of the book.

15. The method as recited in claim 14, wherein the causing the one or more electronic output components to provide the story enhancement effect comprises causing the one or more electronic output components to provide the story enhancement effect as the current page of the book is being turned and prior to the next page of the book being open.

16. The method as recited in claim 9, wherein the one or more electronic output components comprise one or more of speakers, light sources, or a display.

17. The method as recited in claim 9, wherein the one or more electronic output components are integrated with the book.

18. The method as recited in claim 9, wherein the one or more electronic output components are located remote from the book.

19. A media device comprising:
one or more electronic output components;
one or more processors;
computer-readable storage media comprising instructions stored thereon that, responsive to execution by the one or more processors, implement a story controller, the story controller configured to:
receiving story data associated with a book;
receiving page data indicating a current page of the book that is open;
receiving motion data indicating an acceleration of a page turn of a book;
determining a story enhancement effect by selecting the story enhancement effect that is associated, in the story data, with the current page of the book that is open and the acceleration of the page turn; and
controlling the one or more electronic output components to provide the story enhancement effect.

20. The media device as recited in claim 19, wherein the one or more electronic output components comprise one or more of a speaker, one or more light sources, or a display.
